(19) United States
(12) Patent Application Publication
(10) Pub. No.: US 2011/0246557 A1
(43) Pub. Date: Oct. 6, 2011

(54) WEB CONTENT DISTRIBUTION SYSTEM

(75) Inventor: Toshio ENOMOTO, Kanagawa (JP)

(73) Assignee: NEC Electronics Corporation

(21) Appl. No.: 12/751,326

(22) Filed: Mar. 31, 2010

(30) Foreign Application Priority Data
Mar. 31, 2010 (JP) 2009-087852

(51) Int. Cl. G06F 15/16

(52) U.S. Cl. 709/203; 709/224

(57) ABSTRACT

A web content distribution system includes a web content server; a relay server; and a client device. The web content server stores content data. The relay server stores additional information and is connected to the web content server through a network. The client device stores a web browser and is connected to the web content server and the relay server through the network. The relay server extracts a start tag indicating a start of the content data and an end tag indicating an end of the content data. The relay server adds the additional information to the content data in a subsequent part of the end tag to supply to the client device.

### INCORPORATION BY REFERENCE

This application is based upon and claims the benefit of priority from Japanese patent application No. 2009-087852 filed on Mar. 31, 2009, the disclosure of which is incorporated herein in its entirety by reference.

### BACKGROUND OF THE INVENTION

1. Field of the Invention

The present invention relates to a web content distribution system.

2. Description of Related Art

In recent years, many computer systems use web browsers (such as Internet Explorer (registered trademark) and FIREFOX (registered trademark)) as a user interface. A wide range of languages is used in these web browsers, including not only HTML (registered trademark) but also JAVA (registered trademark) and Flash (registered trademark) or the like.

Owing to increased opportunities to use web browsers as a user interface, users who are less experienced in using a computer and users who use a computer less frequently and the like have more opportunities to use web browsers. There is known a technique, in browsing by web browsers, to supply guidance adapted to use opportunity and information to prevent an input error or other information (e.g. refer to Japanese Patent Publication JP2006-268736A (Patent literature 1) and Japanese Patent Publication JP2005-196504A (Patent literature 2: corresponding to US2005198202 (A1))).

FIG. 1 is a block diagram showing a configuration of an HTML page sharing system according to the patent literature 1. In the HTML page sharing system according to the patent literature 1, a plurality of users carries a collaborative work by sharing an HTML page as contents, reflecting their operations on the contents and displaying the results on a web browser. FIG. 2 is a flowchart showing a processing flow in the HTML page sharing system. In the conventional HTML page sharing system, an operation made by a certain user is not reflected on a screen, namely sharing restriction is applied frequently. The patent literature 1 discloses a technique to allow a user to promptly grasp whether or not the sharing restriction is applied.

FIG. 3 is a block diagram showing a screen, which indicates whether or not the sharing restriction is applied on a web browser, in the HTML page sharing system according to the patent literature 1. In the HTML page sharing system according to the patent literature 1, marks are added to an HTML page by using sharing restriction analysis means. As shown in FIG. 3, a circle mark which indicates sharing restriction is not applied is added to a first input region, and an X mark which indicates sharing restriction is applied is added to a second input region and a button region. Accordingly, in the HTML page sharing system according to the patent literature 1, a user who looks at this screen on a web browser can promptly determine whether or not sharing restriction is applied. The HTML page sharing system according to patent literature 1 further carries out user access restriction based on the sharing restriction.

The technique according to the patent literature 1 analyzes sharing restriction by using a property provided in an HTML tag as a source, and adds the information to HTML to display on the browser. FIG. 4 shows a list for providing browsing information, which includes a tag to which a sharing restriction property is added in advance, at a server side, in the technique according to the patent literature 1. The patent literature 1 discloses a technique to add sharing restriction information by such a method. There is also a method disclosed to add sharing restriction information lastly by providing a tag analysis function in a relay server and a web browser.

FIG. 5 is a block diagram showing a configuration of a system which enables communication by a tag by providing a tag function in a client computer according to the patent literature 2. In the system according to the patent literature 2, a server has browsing information and tag information, which can be displayed on a web browser, and a script to arrange the tag information, and further has a system to add tag information to browsing information. The tag is displayed by being piled on original contents. The system according to the patent literature 2 also has a function to rewrite tag information sent from a plurality of clients. Therefore, a communication means using a tag is realized among clients.

We have now discovered the following facts.

In the technique according to the patent literature 1, a tag related to sharing restriction information is required. In order to add the tag, it is necessary to construct a system such that a group, which adds a tag related to sharing restriction information, can change browsing information independently. Therefore, it is extremely difficult to add a tag related to sharing restriction information to contents, which are prohibited from changing due to copyright or other reasons. It is also difficult to make a tag correspond to a support system which adds usage guide and information adapted to a displayed page.

In a technique according to the patent literature 2, a tag is added in a form of being overlaid on a screen of a web browser. However, this tag is realized by a program on a server side. Data transmitted from a server to a web browser of a client also includes tag information to be overlaid. As described above, the technique according to the patent literature 2 also corresponds to a system which can change browsing information independently. Therefore, it is extremely difficult to apply the system to contents which are prohibited from changing due to copyright or other reasons.

As stated above, a conventional technique is provided on an assumption that a subject itself to which information is added is its own information and information authorized to change. Accordingly, additional information is provided in a form of being embedded in original content information (HTML description).

In web contents such as HTML, a technique is desired to add additional information and additional function without changing descriptions of original data of web contents.

### SUMMARY

The present invention seeks to solve one or more of the above problems, or to improve upon those problems at least in part.

In one embodiment, a web content distribution system includes a web content server; a relay server; and a client device. The web content server stores content data. The relay server stores additional information and is connected to the web content server through a network. The client device stores a web browser and is connected to the web content server and the relay server through the network. The relay server extracts a start tag indicating a start of the content data and an end tag indicating an end of the content data. The relay server adds the additional information to the content data in a subsequent part of the end tag to supply to the client device.

In another embodiment, a relay server, which is connected through a network to a client device and a web content server storing content data, includes: an additional information storage portion; a page request response portion; and an additional information conversion portion. The additional information storage portion stores additional information. The page request response portion extracts a start tag indicating a start of the content data and an end tag indicating an end of the content data. The relay server adds the additional information to the content data in a subsequent part of the end tag to supply to the client device.

In another embodiment, a web content distribution method includes: reading out content data; reading out additional information; and supplying the content data and the additional data to a client device. The supplying step includes: extracting a start tag indicating a start of the content data and an end tag indicating an end of the content data, and adding the additional information to the content data in a subsequent part of the end tag to supply to the client device.

According to the present invention, additional information and additional function can be added without changing descriptions of original data of web contents.

### BRIEF DESCRIPTION OF THE DRAWINGS

The above and other objects, advantages and features of the present invention will be more apparent from the following description of certain preferred embodiments taken in conjunction with the accompanying drawings, in which:

FIG. 1 is a block diagram showing a configuration of a conventional HTML page sharing system;

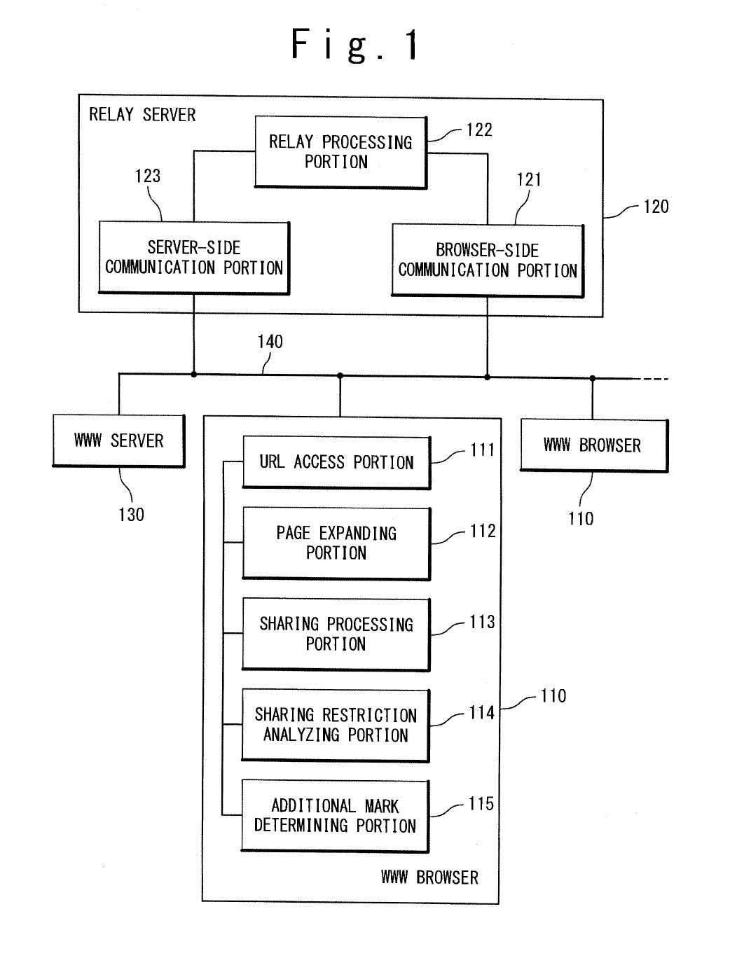

FIG. 2 is a flowchart showing a processing flow in the conventional HTML page sharing system;

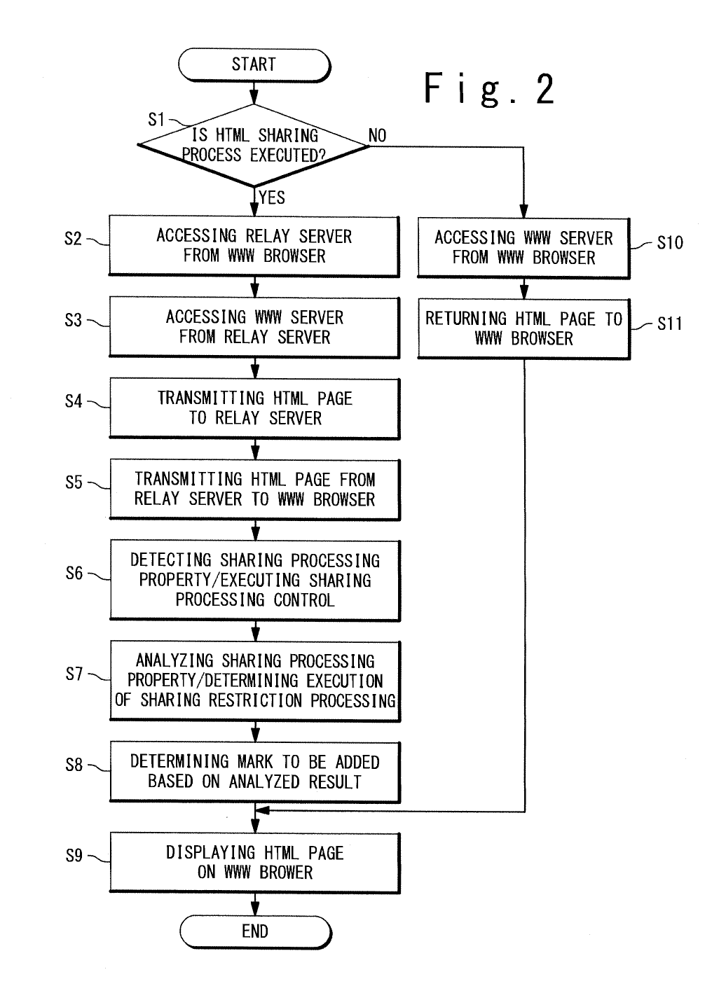

FIG. 3 is a block diagram showing a screen, which indicates whether or not sharing restriction is applied on a web browser, in the conventional HTML page sharing system;

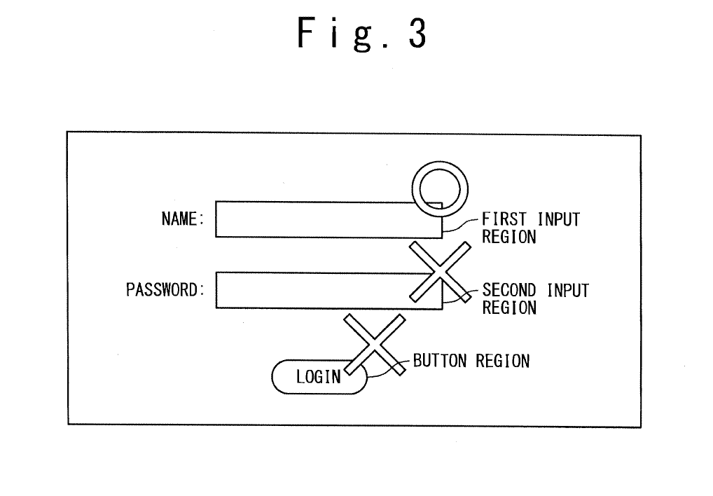

FIG. 4 shows a list for providing browsing information, which includes a tag to which a sharing restriction property is added in advance at a server side;

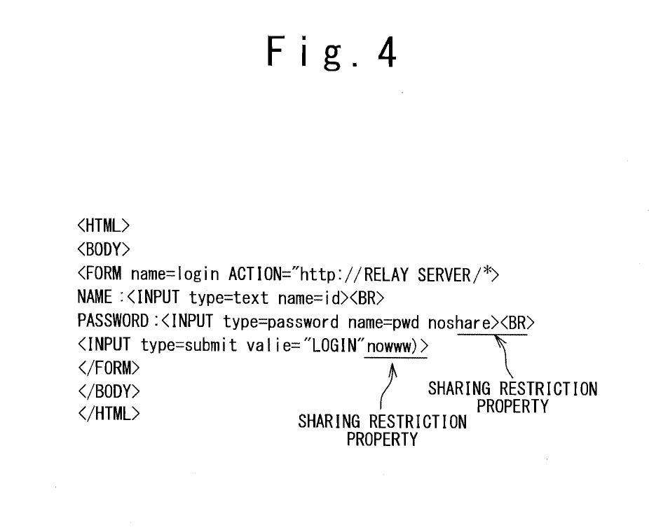

FIG. 5 is a block diagram showing a configuration of a conventional system which enables communication by a tag by providing a tag function in a conventional client computer;

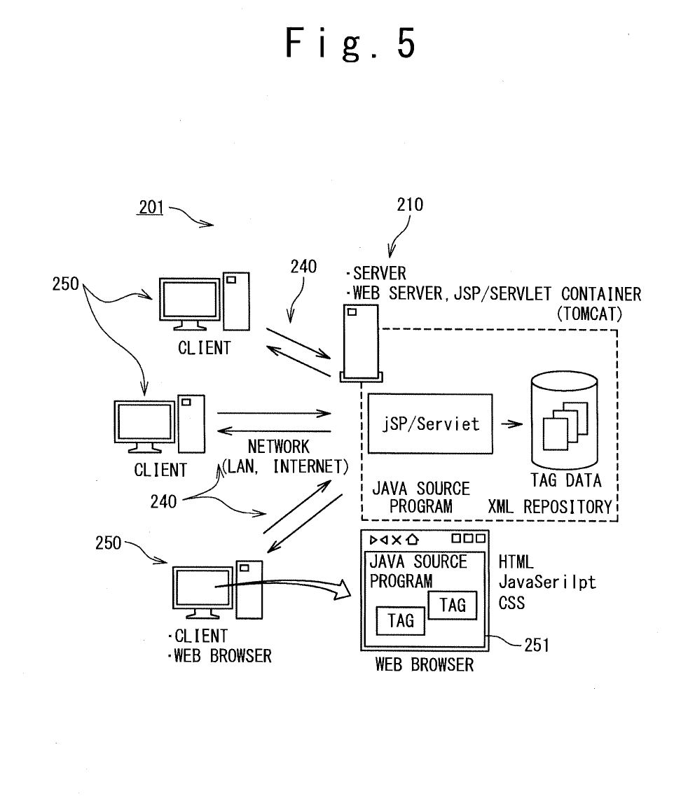

FIG. 6 is a block diagram exemplifying a configuration of a web content distribution system 1 according to the present embodiment;

FIG. 7 is a block diagram exemplifying a detailed configuration of the web content distribution system 1 according to the present embodiment;

FIG. 8 is a flowchart exemplifying an operation in the web content distribution system 1 according to the present embodiment;

FIG. 9 is a sequence diagram showing message responses executed between a relay server 3 and a client device 4;

FIG. 10 is a conceptual diagram exemplifying an operation according to the present embodiment conceptually;

FIG. 11 shows a list (HTML content data) exemplifying a configuration of content data 6;

FIG. 12 is a diagram exemplifying a configuration of a screen in a case that HTML content data is displayed;

FIG. 13 shows a list (HTML additional information data) exemplifying a configuration of additional information 7;

FIG. 14 is a diagram exemplifying a configuration of a screen in a case that HTML additional information data is displayed;

FIG. 15 is a diagram exemplifying a configuration of a screen of the client device 4;

FIG. 16 is a block diagram exemplifying a configuration of a web content distribution system 1 according to a second embodiment; and

FIG. 17 is a block diagram exemplifying a configuration of the web content distribution system 1 according to the second embodiment.

### DESCRIPTION OF THE PREFERRED EMBODIMENTS

The invention will be now described herein with reference to illustrative embodiments. Those skilled in the art will recognize that many alternative embodiments can be accomplished using the teachings of the present invention and that the invention is not limited to the embodiments illustrated for explanatory purposed.

Embodiments of the present invention will be explained below with reference to attached drawings. Note that, in the drawings to explain the embodiments, like reference numbers refer to like members in principle and repetitive explanation thereof will be omitted. Note that, in following explanation, the present embodiment is explained by using a word “page” such as a “page request”. This expression comes from assuming one display screen as a page of a book when a user sees specific contents by using a web browser 8 to be described later. This concept comes from likening an operation to switch a screen by clicking a link on the web browser 8 to turning a page of a book. When content data 6 is seen through the web browser 8, it seems like an aggregate of pages.

### First Embodiment

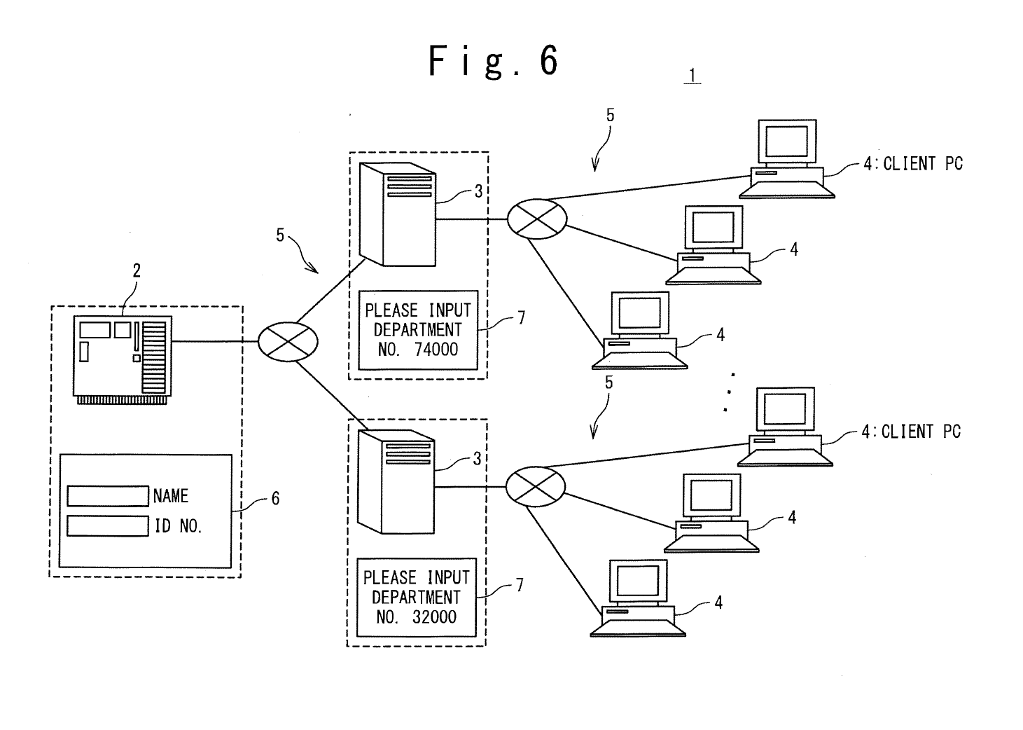

A first embodiment to carry out the present invention will be explained below. FIG. 6 is a block diagram exemplifying a configuration of a web content distribution system 1 according to the present embodiment. The web content distribution system 1 includes a web content server 2, a relay server 3 and a client device 4, which are connected with each other via a network 5. The web content server 2 stores the content data 6. The relay server 3 stores additional information 7. The client device 4 stores the web browser 8 to be described later. The relay server 3 is connected to each of the web content server 2 and the client device 4. The relay server 3 according to the present embodiment may also be installed in, for example, each department. The relay server 3 may also be connected to a plurality of the client devices 4 or other devices in each department. If the relay server 3 is installed in each department with additional information suitable for the department, the additional information stored by the relay server 3 in each department is displayed in the client device 4 belonging to the department.

Note that, in the web content distribution system 1 according to the present embodiment, each of the web content server 2 and the client device 4 is a general information processing device which is widely disseminated. Accordingly, for easy understanding of the present invention, detailed explanation regarding an internal configuration of the device will be omitted. A procedure to send the content data 6 and a procedure to display a screen on the web browser 8 also correspond to general methods which are widely disseminated. Accordingly, detailed explanation regarding these procedures will be omitted.

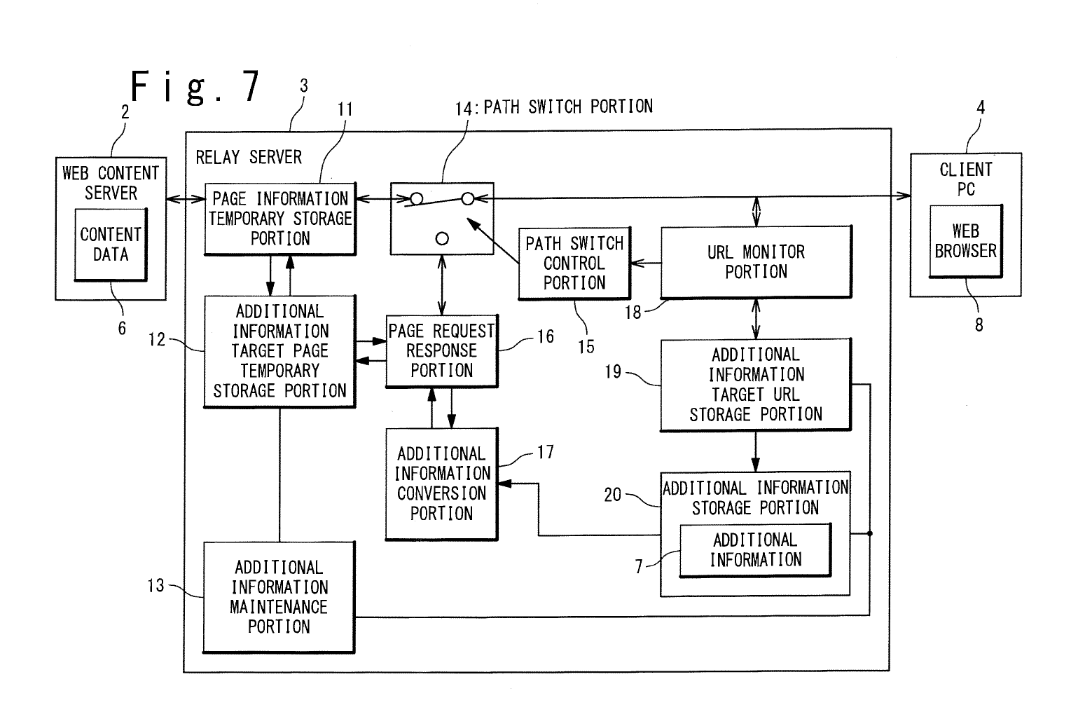

FIG. 7 is a block diagram exemplifying a detailed configuration of the web content distribution system 1 according to the present embodiment. As stated above, the web content distribution system 1 according to the present embodiment is provided with the web content server 2, the relay server 3 and the client device 4, which are connected to each other via the network 5.

The relay server 3 includes a page information temporary storage portion 11, an additional information target page temporary storage portion 12, an additional information maintenance portion 13, a path switch portion 14, a path switch control portion 15, a page request response portion 16, an additional information conversion portion 17, a URL monitor portion 18, an additional information target URL storage portion 19, and an additional information storage portion 20. The additional information storage portion 20 in the relay server 3 stores the additional information 7. The client device 4 includes the web browser 8. The web content server 2 stores the content data 6.

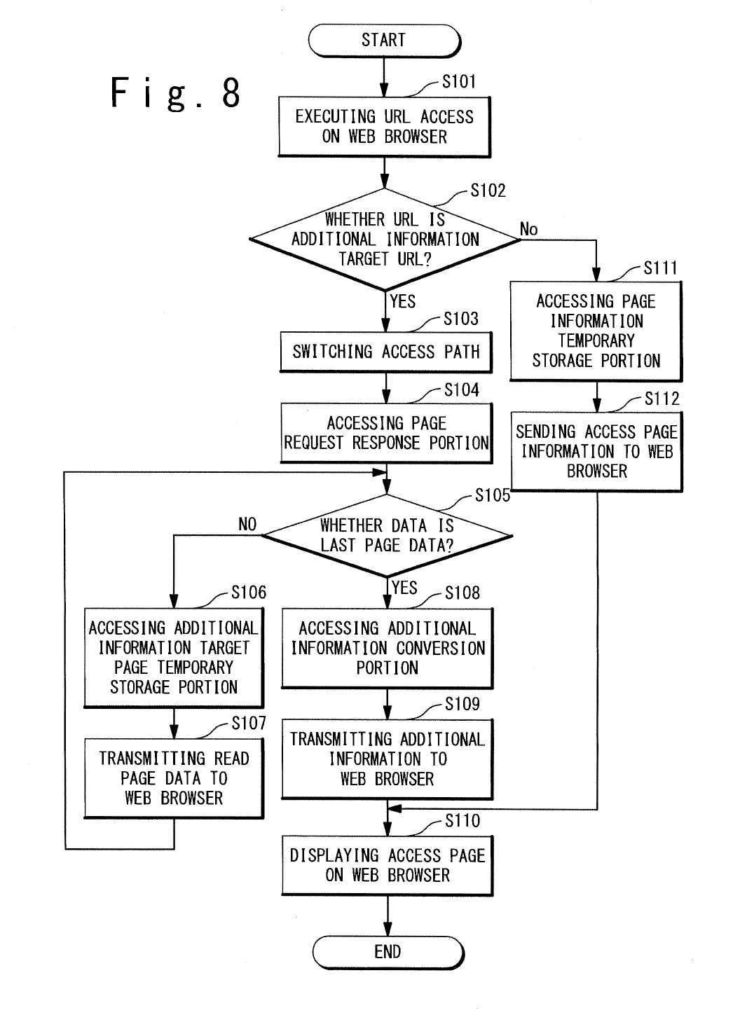

An operation in the web content distribution system 1 according to the present embodiment will be explained below. FIG. 8 is a flowchart exemplifying an operation in the web content distribution system 1 according to the present embodiment. In the present embodiment, an operation starts when a user of the client device 4 tries to see the content data 6 by using the web browser 8. In a step S101, the client device 4 executes URL access with respect to a URL which is desired to browse on the web browser 8.

In a step S102, an access request is sent from the client device 4 to the relay server 3. The URL monitor portion 18 in the relay server 3 determines whether or not the URL corresponding to the access request is an additional information target URL by referring to the additional information target URL storage portion 19. If the determination result indicates it is an additional information target URL, the process will move onto a step S103. Also, if the determination result indicates it is not an additional information target URL, the process will move onto a step S111.

In the step S111, since the URL corresponding to the access request is not an additional information target URL, the client device 4 accesses the page information temporary storage portion 11. In a step S112, page information stored in the page information temporary storage portion 11 is read out and sent to the web browser 8. After that, the process will move onto a step S110.

In the step S103, the path switch control portion 15 activates the path switch portion 14 to switch an access path. In a step S104, the client device 4 accesses the page request response portion 16.

In a step S105, the page request response portion 16 accesses the additional information target page temporary storage portion 12 in which the content data 6 stored in the web content server 2 is partially cached. The page request response portion 16 executes determination of whether or not data which was read out from the additional information target page temporary storage portion 12 is last page data. If the determination result indicates it is last page data, the process will move onto S108. If the determination result indicates it is not last page data, the process will move onto S106. In the step S106, the page request response portion 16 reads out page data by referring to the additional information target page temporary storage portion 12. In a step S107, the page request response portion 16 transmits the read page data to the web browser 8. The steps S106 and S107 are repeated until the determination result indicates it is last page data in the step S105.

In the step S108, the page request response portion 16 accesses the additional information conversion portion 17. In a step S109, the additional information conversion portion 17 transmits the additional information 7, which was obtained by referring to the additional information storage portion 20, to the web browser 8 via the page request response portion 16 so as to continuously follow last data of previously transmitted page data.

In the step S110, at the web browser 8 of the client device 4, an access page is displayed with additional information on the web browser 8. Note that a process to cache the content data 6, which is stored in the web content server 2, in the additional information target page temporary storage portion 12 via the page information temporary storage portion 11 is executed in a background of the flow shown in FIG. 8.

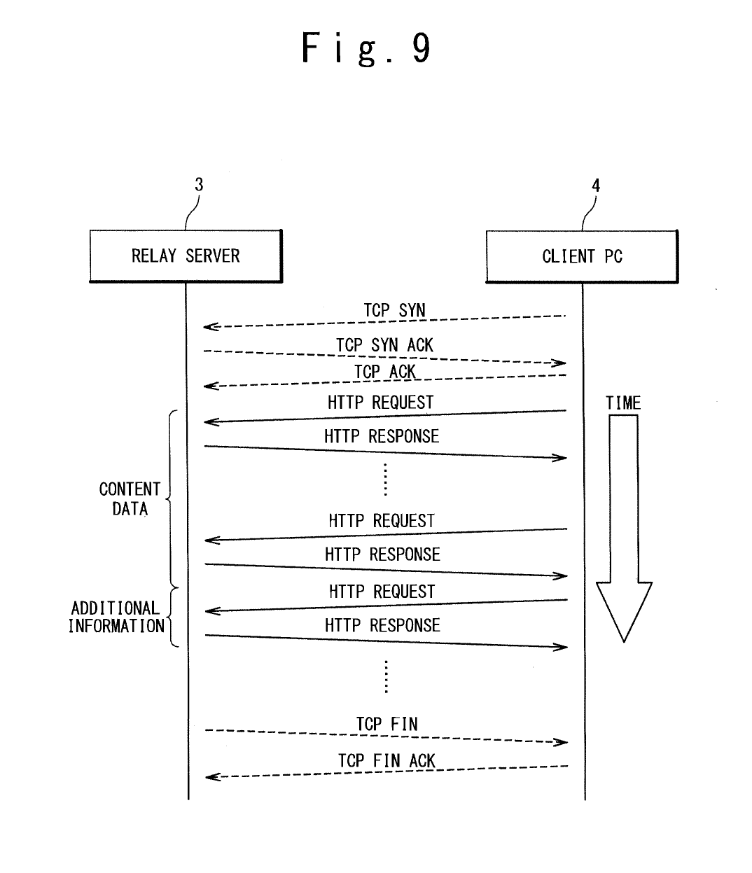

FIG. 9 is a sequence diagram showing message responses executed between the relay server 3 and the client device 4. FIG. 9 exemplifies an operation to supply the content data 6, which is supplied from the web content server 2, and the additional information 7, which is supplied from the relay server 3, to the client device 4 in accordance with the elapse of time.

A page request from the client device 4 to the relay server 3 starts from TCP SYN shown by a broken line arrow. Based on TCP SYN, a process to establish a transmission path is initially dealt with. As shown in FIG. 9, after establishment of the transmission path, then, a process of HTTP responses is executed. Content displayed on the web browser is usually provided with one page which is in a range surrounded by HTML tags <html> and </html>. The web browser 8 executes a process by recognizing the </html> tag as a terminal end of a page.

It may be considered that responses of the TCP transmission path shown by broken line arrows are inserted in responses of the content data 6 and the additional information 7, and responses of the content data 6 and the additional information 7 are cut off. However, referring to FIG. 9, in the web content distribution system 1 according to the present embodiment, detecting a terminal end of a page of the content data 6 is followed by sending the additional information 7 by the relay server 3. Therefore, the additional information 7 is supplied without being cut off. More specifically, descriptions:

<html>
content data
</html>
<html>
additional information
</html>

are transmitted.

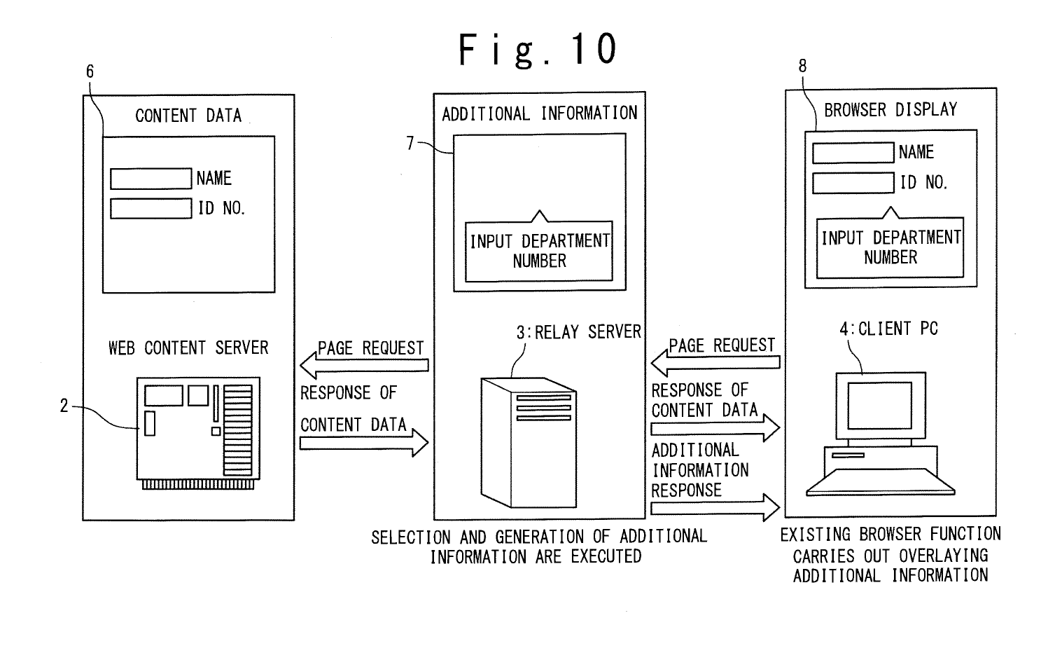

When HTML in the above format is received, the web browser 8 constructs a display screen by combining the content data 6 and the additional information 7 so as to reflect it on a display device of the client device 4. FIG. 10 is a conceptual diagram which exemplifies an operation according to the present embodiment conceptually. FIG. 10 conceptually exemplifies an operation in browsing the content data 6 and the additional information 7 on the web browser 8 and a configuration of a screen obtained therein. Referring to FIG. 10, a page request is supplied from the client device 4 to the web content server 2 via the relay server 3. In response to the page request, the web content server 2 transmits a response of the content data 6 to the client device 4 via the relay server 3. The relay server 3 transmits, as an additional information response, the additional information 7 which is stored internally in the relay server 3 so as to continuously follow the end of the response of the content data 6. The client device 4 combines the content data 6 and the additional information 7 by a function of the web browser 8 and images the data/information so that a user can recognize visually. The content data 6 and the additional information 7, which were subjected to imaging, are displayed on a display device of the client device 4 as shown in FIG. 10. An operation to combine images can be realized by using a function mounted on existing web browsers (e.g. Internet Explorer and FIREFOX). In the web content distribution system 1 according to the present embodiment, a response of the content data 6 and a subsequent response of the additional information 7 are executed in accordance with a predetermined format and combined on the web browser 8.

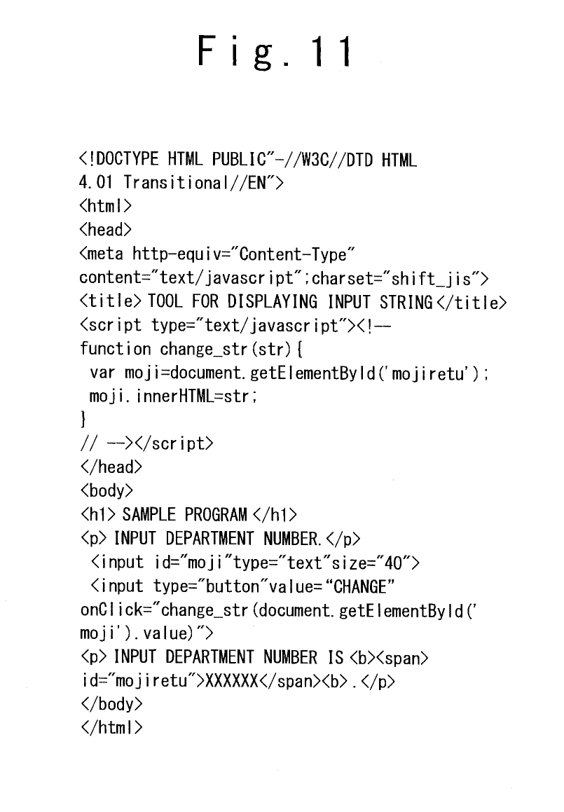

FIG. 11 shows a list (HTML content data) exemplifying a configuration of the content data 6 which can be stored by the web content server 2 in the web content distribution system 1 according to the present embodiment. The list (HTML content data) includes descriptions:

<html>
content data
</html>

as shown in FIG. 11.

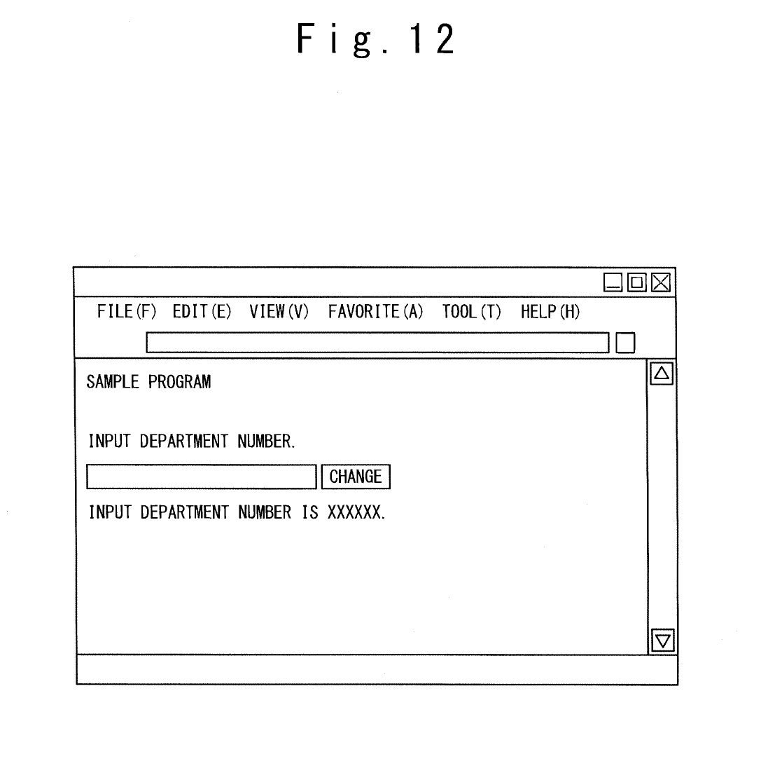

FIG. 12 exemplifies a configuration of a screen on a display device when the list (HTML content data) is displayed on the web browser 8 of the client device 4. As shown in FIG. 12, the web browser 8 displays information indicated by the list (HTML content data) shown in FIG. 11 in a state such that a user can recognize visually.

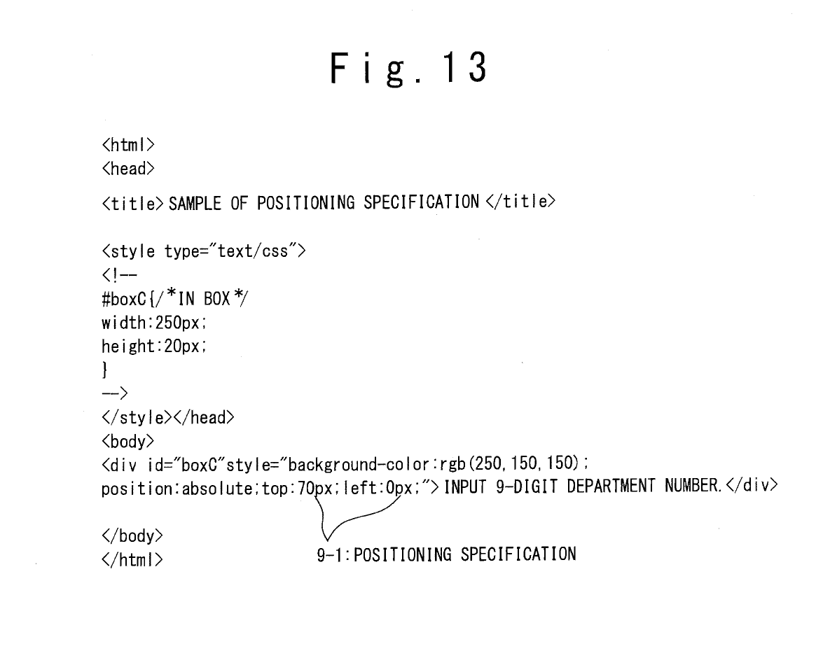

FIG. 13 shows a list (HTML additional information data) exemplifying a configuration of the additional information 7 which can be stored by the relay server 3. The list (HTML additional information data) includes descriptions:

<html>
additional information
</html>

as shown in FIG. 13. The list (HTML additional information data) also includes “positioning specification” to specify a position for overwriting.

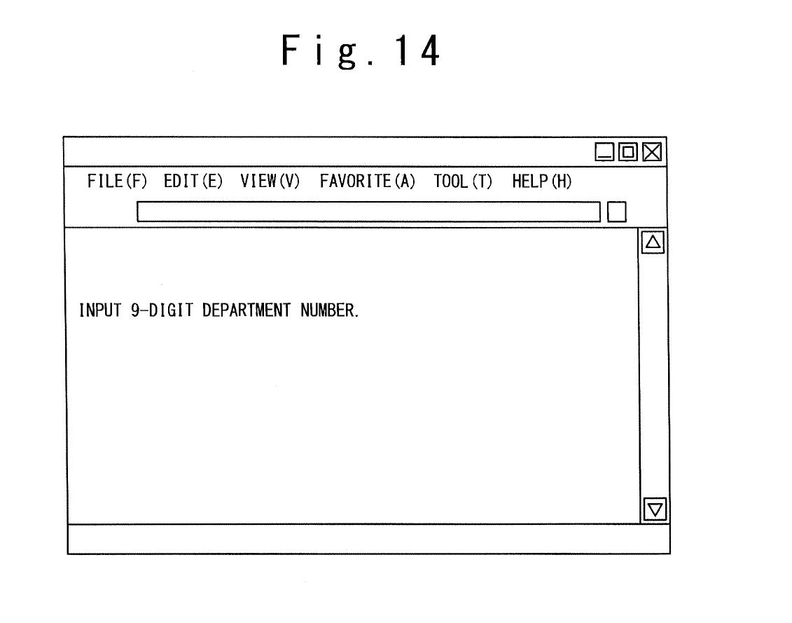

FIG. 14 exemplifies a configuration of a screen on a display device when the list (HTML additional information data) is displayed on the web browser 8 of the client device 4. As shown in FIG. 14, the web browser 8 displays information indicated by the list (HTML additional information data) shown in FIG. 13 in a state such that a user can recognize visually.

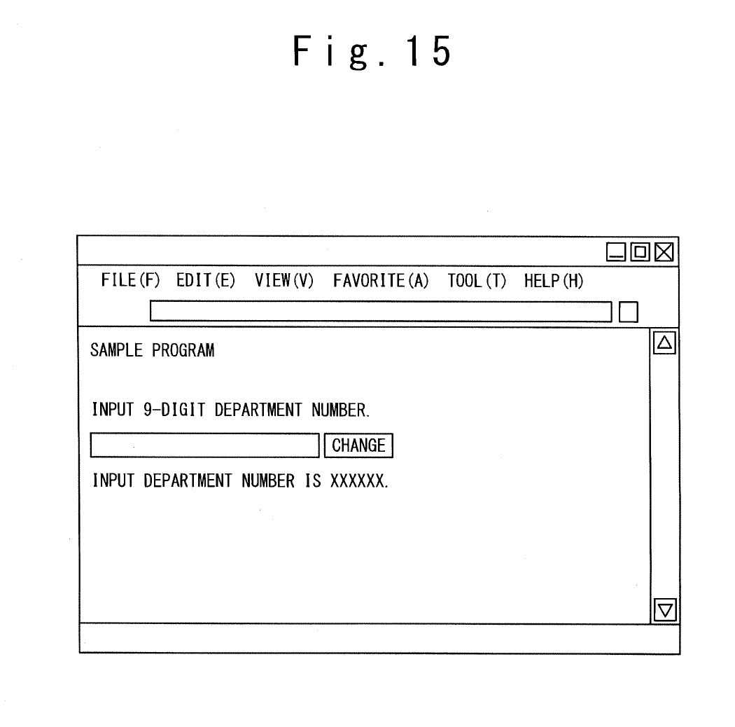

FIG. 15 exemplifies a configuration of a screen on a display device of the client device 4 when these data is applied by the web content distribution system 1 according to the present embodiment. As shown in FIG. 15, a display region of the web browser 8 is provided in a form in which the additional information 7 is overwritten on the content data 6. A character string of “input department number” in the content data 6 is overwritten by a character string of “input 9-digit department number” in the additional information 7. Therefore, the original character string of “input department number” cannot be seen from a user. Note that a position to overwrite a character string can be changed by changing a value of the above “positioning specification”. In the web content distribution system 1 according to the present embodiment, the additional information maintenance portion 13 in the relay server 3 preferably has a function to support the positioning when the content data 6 and the additional information 7 are combined and displayed. That is, the additional information maintenance portion 13 has a function for changing a display position of the additional information 7 when the content data 6 and the additional information 7 are combined and displayed on the web browser 8.

### Second Embodiment

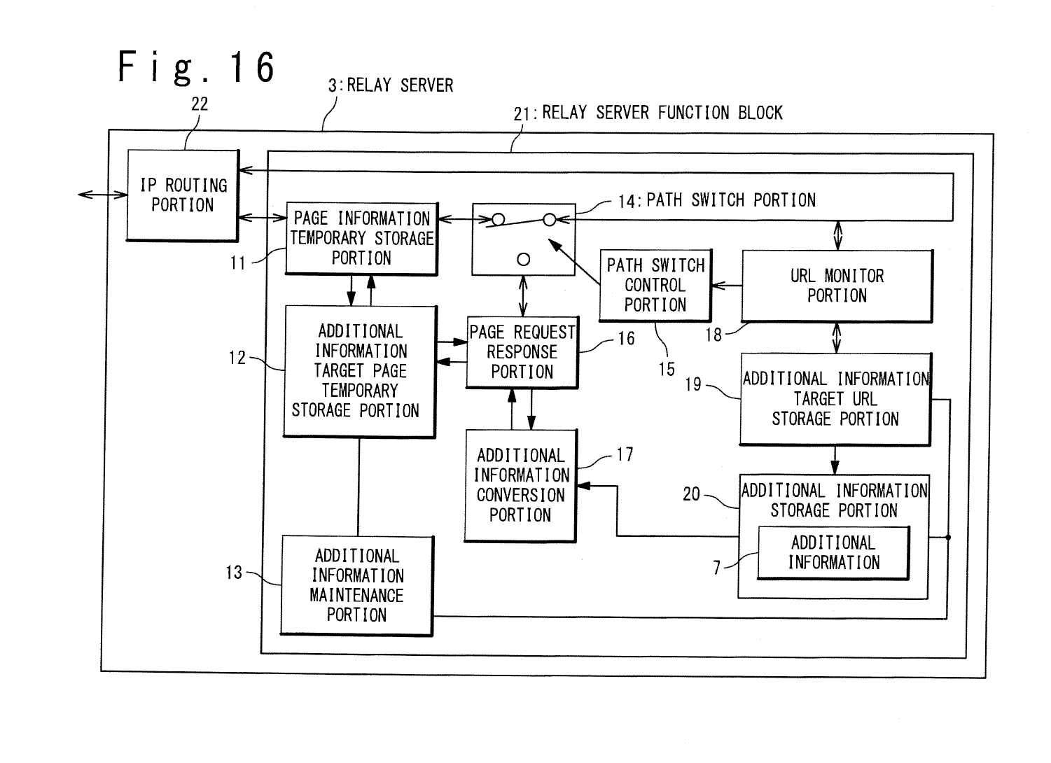

A second embodiment to carry out the present invention will be explained below. FIG. 16 is a block diagram exemplifying a configuration of the web content distribution system 1 according to the second embodiment. As shown in FIG. 16, in the web content distribution system 1 according to the second embodiment, the relay server 3 includes a relay server function block 21 and an IP routing portion 22. The relay server function block 21 provides a function similar to that of the relay server 3 according to the first embodiment. The relay server function block 21 provides a function such as replacing address information of a web access request sent from a client PC in a certain management IP address region, and caching data which was accessed in the past.

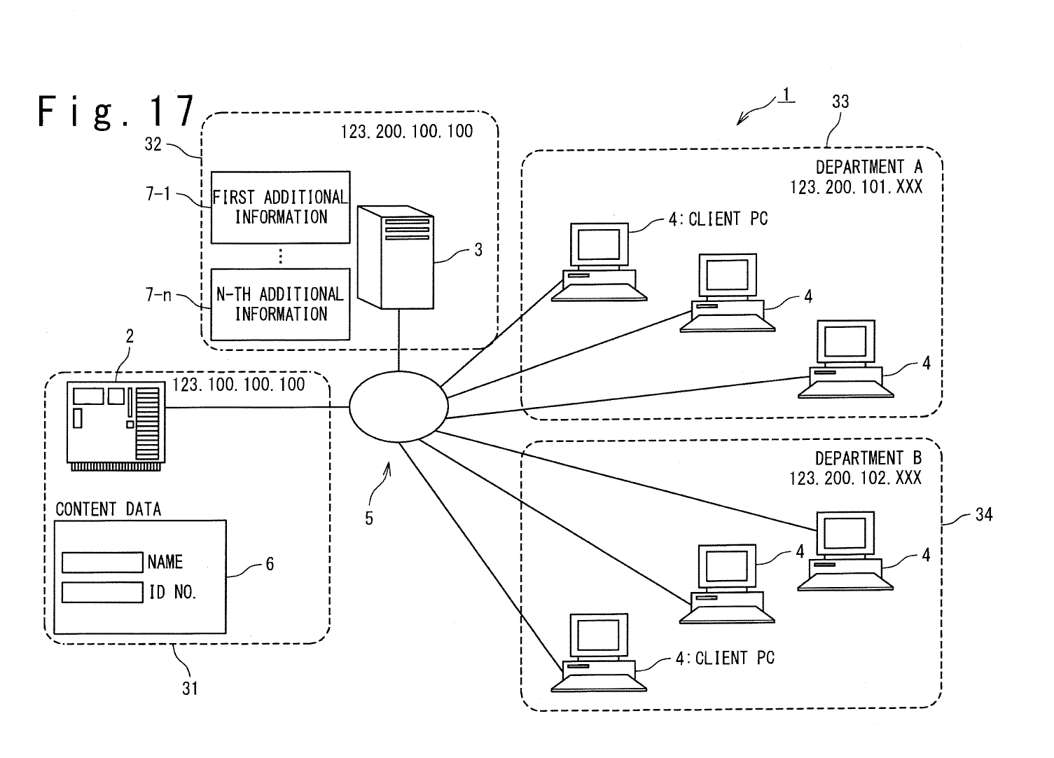

FIG. 17 is a block diagram exemplifying a configuration of the web content distribution system 1 according to the second embodiment. The relay server 3 (IP routing portion 22) in the second embodiment constructs a logical network in a range from a distribution side 31 to a department B group 34 in accordance with IP address allocations as shown in FIG. 17. The web content distribution system 1 according to the second embodiment makes it possible to construct a network relatively freely by simply determining IP address allocations even if a logical network configuration differs from a physical network configuration. FIG. 17 exemplifies a case of arranging one relay server 3 for a plurality of departments. Additional information for each of the plurality of the departments (i.e. first additional information 7-1 to n-th additional information 7-n) is stored in the relay server 3. The relay server 3 constructs the web content distribution system 1 corresponding to a logical network by the relay server function block 21.

If the relay server 3 provided with the relay server function block 21 is applied to a network configuration of an IP address system as shown in FIG. 17, the relay server 3 is capable of referring to an IP address included in a response request sent from the client device 4. Therefore, the relay server 3 can determine whether a response request is sent from the client device 4 belonging to a department A group 33 or sent from the client device 4 belonging to the department B group 34. Based on determination information obtained by the determination, the relay server 3 according to the second embodiment appropriately switches additional information to transmit out of the first additional information 7-1 to the n-th additional information 7-n.

As described above, the web content distribution system 1 according to the present invention is capable of displaying a screen to which additional information is added on a web browser of a client PC without adding changes to original data of web content. It is also possible to add additional information prepared by an additional information provider to content data which is not authorized to change due to copyright such as web content software placed on the market and web contents on the Internet. Moreover, the web content distribution system 1 can add optimum information for a department.

The concrete embodiments of the present invention are explained above. It is apparent that the present invention is not limited to the above embodiments, but may be modified and changed without departing from the scope and spirit of the invention.

Although the present invention has been described above in connection with several exemplary embodiments thereof, it would be apparent to those skilled in the art that those exemplary embodiments are provided solely for illustrating the present invention, and should not be relied upon to construe the appended claims in a limiting sense.

What is claimed is:

1. A web content distribution system comprising:
a web content server configured to store content data;
a relay server configured to store additional information and be connected to said web content server through a network; and
a client device configured to store a web browser and be connected to said web content server and said relay server through said network,
wherein said relay server extracts a start tag indicating a start of said content data and an end tag indicating an end of said content data, and
said relay server adds said additional information to said content data in a subsequent part of said end tag to supply to said client device.

2. The web content distribution system according to claim 1, wherein said relay server describes, in a subsequent part of HTML data in which said content data is surrounded by HTML tags <html> and </html>, another HTML data in which said additional information is surrounded by other HTML tags <html> and </html>.

3. The web content distribution system according to claim 2, wherein said relay server includes:
a page information temporary storage portion configured to store said content data supplied from said web content server,
an additional information target page temporary storage portion configured to store an additional information target page included in said content data,
an additional information storage portion configured to store additional information,
a page request response portion configured to extract said start tag and said end tag, and
an additional information conversion portion,
wherein said page request response portion accesses said additional information conversion portion, when data of said additional information target page read from said additional information target page temporary storage portion is last page data,
wherein said additional information conversion portion obtains said additional information by referring said additional information storage portion, and
wherein said page request response portion receives said additional information from said additional information conversion portion and describes said received additional information subsequent to said last page data to supply to said client device.

4. The web content distribution system according to claim 3, wherein said relay server further includes:
an URL monitor portion configured to determine whether or not a URL corresponding to a received access request is an additional information target URL which is a target for adding said additional information,
an additional information target URL storage portion configured to store said additional information target URL,
a path switch portion configured to switch a receiving path for said content data, and
a path switch control portion configured to control connection in said path switch portion based on instructions from said URL monitor portion.

5. The web content distribution system according to claim 4, wherein said relay server further includes:
an additional information maintenance portion configured to have a function for changing a display position of said additional information when said content data and said additional information are combined and displayed on said web browser.

6. The web content distribution system according to claim 1, wherein said relay server further includes:
an IP routing portion configured to construct a logical network based on a predetermined IP address allocations.

7. A relay server, which is connected through a network to a client device and a web content server storing content data, comprising:
an additional information storage portion configured to store additional information;
a page request response portion configured to extract a start tag indicating a start of said content data and an end tag indicating an end of said content data; and
an additional information conversion portion,
wherein said relay server adds said additional information to said content data in a subsequent part of said end tag to supply to said client device.

8. The relay server according to claim 7, further comprising:
a page information temporary storage portion configured to store said content data supplied from said web content server; and
an additional information target page temporary storage portion configured to store an additional information target page included in said content data,
wherein said page request response portion accesses said additional information conversion portion, when data of said additional information target page read from said additional information target page temporary storage portion is last page data,
wherein said additional information conversion portion obtains said additional information by referring said additional information storage portion, and
wherein said page request response portion receives said additional information from said additional information conversion portion and describes said received additional information subsequent to said last page data to supply to said client device.

9. The relay server according to claim 8, further comprising:
an URL monitor portion configured to determine whether or not a URL corresponding to a received access request is an additional information target URL which is a target for adding said additional information;
an additional information target URL storage portion configured to store said additional information target URL,
a path switch portion configured to switch a receiving path for said content data; and
a path switch control portion configured to control connection in said path switch portion based on instructions from said URL monitor portion.

10. The relay server according to claim 9, further comprising:
an additional information maintenance portion configured to have a function for changing a display position of said additional information when said content data and said additional information are combined and displayed on said web browser.

11. The relay server according to claim 7, wherein said page request response portion describes, in a subsequent part of HTML data in which said content data is surrounded by HTML tags <html> and </html>, another HTML data in which said additional information is surrounded by other HTML tags <html> and </html>.

12. The relay server according to claim 7, further comprising:
an IP routing portion configured to construct a logical network based on a predetermined IP address allocations.

13. A web content distribution method comprising:
reading out content data;
reading out additional information; and
supplying said content data and said additional data to a client device,
wherein said supplying step includes:
extracting a start tag indicating a start of said content data and an end tag indicating an end of said content data, and
adding said additional information to said content data in a subsequent part of said end tag to supply to said client device.

14. The web content distribution method according to claim 13, wherein said adding step includes:
describing, in a subsequent part of HTML data in which said content data is surrounded by HTML tags <html> and </html>, another HTML data in which said additional information is surrounded by other HTML tags <html> and </html>.

15. The web content distribution method according to claim 14, wherein said extracting step includes:
reading out an additional information target page included in said content data,
wherein said adding step includes:
receiving said additional information when data of said additional information target page is last page data, and
describing said received additional information subsequent to said last page data.
